(19) United States
(12) Patent Application Publication
(10) Pub. No.: US 2008/0138708 A1
(43) Pub. Date: Jun. 12, 2008

(54) CATHODE ACTIVE MATERIAL, NON-AQUEOUS ELECTROLYTE SECONDARY BATTERY USING THE SAME, AND MANUFACTURING METHOD OF CATHODE ACTIVE MATERIAL

(75) Inventors: Haruo Watanabe, Kanagawa (JP); Masayoshi Isago, Miyagi (JP); Tomoyo Ooyama, Fukushima (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/941,602

(22) Filed: Nov. 16, 2007

(30) Foreign Application Priority Data
Nov. 28, 2006 (JP) 2006-320348

(51) Int. Cl. H01M 4/38; H01M 4/50; H01M 4/52; B05D 3/00; B05D 1/18

(52) U.S. Cl. 429/220; 429/224; 429/223; 429/231.3; 429/221; 429/229; 427/126.6; 427/126.4

(57) ABSTRACT

A cathode active material has: a composite oxide particle containing at least lithium Li and cobalt Co; and a coating layer provided in a part of the composite oxide particle and having an oxide containing Li and an element of one of nickel Ni, manganese Mn, and cobalt Co. A ratio [Ni(T)Co(S)/Ni(S)Co(T)] of an atomic ratio [Ni(T)/Co(T)] of Ni to Co as an average of the whole cathode active material to an atomic ratio [Ni(S)/Co(S)] of Ni to Co in the surface of the cathode active material is larger than a ratio [Mn(T)Co(S)/Mn(S)Co(T)] of an atomic ratio [Mn(T)/Co(T)] of Mn to Co as an average of the whole cathode active material to an atomic ratio [Mn(S)/Co(S)] of Mn to Co in the surface of the cathode active material.

### CROSS REFERENCES TO RELATED APPLICATIONS

The present application claims priority to Japanese Patent Application JP 2006-320348 filed in the Japanese Patent Office on Nov. 28, 2006, the entire contents of which is being incorporated herein by reference.

### BACKGROUND

The present application relates to a cathode active material, a non-aqueous electrolyte secondary battery using such a material, and a manufacturing method of the cathode active material. More particularly, the present application relates to a cathode active material containing a composite oxide containing, for example, lithium Li and cobalt Co, a non-aqueous electrolyte secondary battery using such a material, and a manufacturing method of the cathode active material.

In recent years, a demand for a small secondary battery having a high capacitance is increasing in association with the spread of portable apparatuses such as video camera, notebook-sized personal computer, and the like. Most of the secondary batteries which are used at present are nickel-cadmium batteries each using an alkali electrolytic solution. However, its battery voltage is low to be equal to about 1.2V and it is difficult to improve an energy density. Therefore, there has been examined a lithium secondary battery using a lithium metal in which a specific gravity is smallest to be equal to 0.534 among those of simple substances of solids, an electric potential is extremely low, and a current capacitance per unit weight is largest among those of metal anode materials.

However, in the secondary battery using the lithium metal for an anode, dendroid lithium (dendrite) is precipitated on the surface of the anode upon charging and grows by charge/discharge cycles. The growth of dendrite causes such a problem that cycle characteristics of the secondary battery deteriorate and, in the worst case, the dendrite pierces through a partition film (separator) arranged so that a cathode is not come into contact with the anode and an internal short-circuit is caused, or the like.

For example, as disclosed in Patent Document 1 (JP-A-1987(Showa 62)-90863), a secondary battery in which a carbonaceous material such as cokes or the like is used for the anode and alkali metal ions are doped and dedoped, thereby repeating charging and discharging has been proposed. It has, consequently, been found that the problem of deterioration of the anode due to the repetition of the charging and discharging as mentioned above can be avoided.

As a cathode active material, a material in which the battery voltage is equal to about 4V has been proposed owing to the search and development of the active materials showing a high electric potential and has been highlighted. As such active materials, inorganic compounds such as transition metal oxide containing an alkali metal, transition metal chalcogen, and the like have been known.

Among them, LiₓCoO₂ (0<x≦1.0), LiₓNiO₂ (0<x≦1.0), and the like are most desirable from viewpoints of a high electric potential, stability, and a long life. Among them, the cathode active material constructed mainly by LiCoO₂ is a cathode active material showing a high electric potential and it is expected to raise a charge voltage and increase an energy density. For this purpose, such a technique in which a small amount of LiMn_{1/3}Co_{1/3}Ni_{1/3}O₂ or the like is mixed into the cathode active material and the resultant material is used or its surface is coated with another material has been well known.

In the foregoing technique for modifying the cathode active material by coating the surface of the cathode active material, it is requested to accomplish the high coating performance. Various methods have been proposed to satisfy such an object so that it has been confirmed that the method of coating with a metal hydroxide has the excellent coating performance. With respect such a method, for example, such a technique that the surface of LiNiO₂ is coated with cobalt Co and manganese Mn through the hydroxide coating step has been disclosed in Patent Document 2 (JP-A-1997 (Heisei 9)-265985).

Further, such a technique that the surface of a lithium manganese composite oxide is coated with a non-manganese metal through the hydroxide coating step has been disclosed in Patent Document 3 (JP-A-1999 (Heisei 11)-71114).

### SUMMARY

However, if the surface of the cathode active material is modified by the method in the related art, there is such a problem that when the charging and discharging are repeated with the high capacitance, a capacitance deterioration occurs and a battery life is shortened. At present, it is expected to raise the charge voltage and increase the energy density. As a method of solving the problem of deterioration in charge/discharge cycles characteristics, the surface of the cathode active material constructed mainly by lithium cobalt acid LiCoO₂ is modified. However, as a part of such a method, it is a technical subject to modify the surface by uniformly and strictly coating the surface with a desired metal oxide.

It is, therefore, desirable to provide a cathode active material which has a high capacitance and is excellent in charge/discharge cycle characteristics when the cathode active material is used for a battery, a non-aqueous electrolyte secondary battery using such a material, and a manufacturing method of the cathode active material.

According to an embodiment, there is provided a cathode active material comprising:

a composite oxide particle containing at least lithium Li and cobalt Co; and

a coating layer which is provided in at least a part of the composite oxide particle and has an oxide containing lithium Li and an element of at least one of nickel Ni, manganese Mn, and cobalt Co,

wherein a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in a surface of the cathode active material

is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of the cathode active material.

According to another embodiment, there is provided a non-aqueous electrolyte secondary battery comprising: a cathode containing a cathode active material; an anode; and an electrolyte,

wherein the cathode active material has

a composite oxide particle containing at least lithium Li and cobalt Co and

a coating layer which is provided in at least a part of the composite oxide particle and has an oxide containing lithium Li and an element of at least one of nickel Ni, manganese Mn, and cobalt Co, and

a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in a surface of the cathode active material

is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of the cathode active material.

According to still another embodiment, there is provided a manufacturing method of a cathode active material, comprising the steps of:

forming a layer containing a hydroxide of nickel Ni and/or a hydroxide of manganese Mn into at least a part of a composite oxide particle containing at least lithium Li and cobalt Co; and

forming a coating layer which is provided in at least a part of the composite oxide particle by heat-processing the composite oxide particle formed with the layer and has an oxide containing lithium Li and an element of at least one of nickel Ni, manganese Mn, and cobalt Co,

wherein in the composite oxide particle formed with the coating layer,

a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in a surface of the cathode active material

is larger than a ratio [Mn(T)Co(S)[Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of the cathode active material.

According to an embodiment, the cathode active material has: the composite oxide particle containing at least lithium Li and cobalt Co; and the coating layer which is provided in at least a part of the composite oxide particle and has the oxide containing lithium Li and the element of at least one of nickel Ni, manganese Mn, and cobalt Co. The ratio [Ni(T)Co(S)/Ni(S)Co(T)] of the atomic ratio [Ni(T)/Co(T)] of nickel Ni to cobalt Co as an average of the whole cathode active material to the atomic ratio [Ni(S)/Co(S)] of nickel Ni to cobalt Co in the surface of the cathode active material is larger than the ratio [Mn(T)Co(S)/Mn(S)Co(T)] of the atomic ratio [Mn(T)/Co(T)] of manganese Mn to cobalt Co as an average of the whole cathode active material to the atomic ratio [Mn(S)/Co(S)] of manganese Mn to cobalt Co in the surface of the cathode active material. Therefore, the non-aqueous electrolyte secondary battery which has the high capacitance and is excellent in the cycle characteristics when the cathode active material is used for the battery can be realized.

According to an embodiment, the cathode active material which has the high capacitance and is excellent in the charge/discharge cycle characteristics when the cathode active material is used for the battery, the battery using such a material, and the manufacturing method of the cathode active material can be provided.

Additional features and advantages are described herein, and will be apparent from, the following Detailed Description and the figures.

### BRIEF DESCRIPTION OF THE FIGURES

FIG. 1 is a schematic cross sectional view of a first example of a non-aqueous electrolyte secondary battery using a cathode active material according to an embodiment;

FIG. 2 is a partial enlarged cross sectional view of a winded electrode member shown in FIG. 1;

FIG. 3 is a schematic diagram of a second example of a non-aqueous electrolyte secondary battery using the cathode active material according to an embodiment; and

FIG. 4 is a partial enlarged cross sectional view of a battery element shown in FIG. 3.

### DETAILED DESCRIPTION

An embodiment will be described hereinbelow. A cathode active material according to an embodiment has a coating layer which is provided in at least a part of a composite oxide particle and which has an oxide containing lithium Li and an element of at least one of nickel Ni, manganese Mn, and cobalt Co, wherein a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in the surface of the cathode active material is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of the cathode active material.

First, the reasons why the cathode active material has the above construction will be described. According to the cathode active material constructed mainly by lithium cobalt acid LiCoO₂, although high charge voltage performance and high energy density performance associated therewith can be realized, when the charge/discharge cycles are repeated at a high charge voltage and with a high capacitance, a capacitance deteriorates largely. Since a cause of it is based on a surface of a cathode active material particle, necessity of a surface process of the cathode active material has been pointed out.

Therefore, various surface processes have been proposed. From a viewpoint of eliminating the reduction of the capacitance per volume or weight or minimizing the reduction of the capacitance, by suppressing the reduction of the capacitance or executing the surface process by a material which can contribute to the capacitance, the high charge voltage performance and the high energy density performance associated therewith can be realized and the cathode active material having the excellent charge/discharge cycle characteristics at the high charge voltage can be obtained.

By providing a coating layer having an oxide containing lithium Li and an element of at least one of nickel Ni, manganese Mn, and cobalt Co for the cathode active material constructed mainly by the lithium cobalt acid LiCoO₂, the cathode active material which has the high charge voltage performance and the high energy density performance associated therewith and is excellent in the charge/discharge cycle characteristics at the high capacitance under the high charge voltage condition can be obtained although it is slightly poor in the high charge voltage performance and the high energy density performance associated therewith.

As a method of providing the coating layer for the composite oxide particle, the following methods can be proposed: a method whereby a compound of lithium Li, a compound of nickel Ni, a compound of manganese Mn, and/or a compound of cobalt Co are mixed in a dry manner as micro-pulverized particles with the composite oxide particle, the particle is coated and baked, and the coating layer having the oxide containing lithium Li and the element of at least one of nickel Ni, manganese Mn, and cobalt Co is formed on the surface of the composite oxide particle; and a method whereby the compound of lithium Li, the compound of nickel Ni, the compound of manganese Mn, and/or the compound of cobalt Co are dissolved or mixed into a solvent, the particle is coated and baked in a wet manner and the coating layer having the oxide containing lithium Li and the element of at least one of nickel Ni, manganese Mn, and cobalt Co is formed on the surface of the composite oxide particle. However, according to those methods, such a result that it is difficult to accomplish the coating of high uniformity is obtained.

By coating the surface of the particle with nickel Ni and/or manganese Mn as a hydroxide, heat-dehydrating the hydroxide, and forming the coating layer, the coating of high uniformity can be realized. According to such a coating process, the compound of nickel Ni and/or the compound of manganese Mn is dissolved into a solvent system constructed mainly by the water. Thereafter, the composite oxide particle is dispersed into the solvent system. A basicity of a dispersing system is raised by adding a base to such a dispersing system or by another method. The hydroxide of nickel Ni and/or the hydroxide of manganese Mn is precipitated to the surface of the composite oxide particle.

Further, it has been discovered that the uniformity of the coating onto the composite oxide particle can be further improved by executing the coating process in the solvent system constructed mainly by the water whose pH is equal to 12 or more. In other words, the metal composite oxide particle is preliminarily dispersed into the solvent system constructed mainly by the water whose pH is equal to 12 or more. The compound of nickel Ni and/or the compound of manganese Mn is added to the solvent system. The surface of the metal composite oxide particle is coated with the hydroxide of nickel Ni and/or the hydroxide of manganese Mn.

The composite oxide particle coated with the hydroxide of nickel Ni and/or the hydroxide of manganese Mn by the coating process is heated and dehydrated, thereby forming the coating layer onto the surface of the composite oxide particle. Thus, the uniformity of the coating onto the surface of the composite oxide particle can be improved.

According to the cathode active material manufactured as mentioned above, by using it for the battery, the stability at the high charge voltage is high, the high energy density performance can be accomplished in association therewith, and the charge/discharge cycle characteristics at the high capacitance under the high charge voltage condition can be improved.

In the cathode active material having: the composite oxide particle containing at least lithium Li and cobalt Co; and the coating layer which is provided in at least a part of the composite oxide particle and has the oxide containing lithium Li and the element of at least one of nickel Ni, manganese Mn, and cobalt Co, it is effective that a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in the surface of the cathode active material is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of the cathode active material.

The atomic ratio [Ni(S)/Co(S)] of nickel Ni to cobalt Co in the surface of the cathode active material and the atomic ratio [Mn(S)/Co(S)] of manganese Mn to cobalt Co in the surface of the cathode active material can be calculated by quantifying the cathode active material by using XPS (X-ray Photoelectron Spectroscopy). The atomic ratio [Ni(I)/Co(T)] of nickel Ni to cobalt Co as an average of the whole cathode active material and the atomic ratio [Mn(T)/Co(T)] of manganese Mn to cobalt Co as an average of the whole cathode active material can be calculated by a method whereby a solution in which the cathode active material has uniformly been dissolved by an acid or the like is quantified by using ICP-AES (Inductively Coupled Plasma-Atomic Emission Spectrometry).

That is, in the case of manganese Mn, since it exists in the surface of the cathode active material, it is effective to improve the repetition performance of charge/discharge cycles. However, as a whole region including bulks, an increase in existence amount of manganese causes the reduction in capacitance of the cathode active material. It is, therefore, desirable that manganese Mn selectively and concentratedly exists in the surface of the cathode active material. In the case of nickel Ni, since it exists in the surface of the cathode active material, it is effective to improve the repetition performance of charge/discharge cycles. Further, as a whole region including the bulks, an increase in existence amount of nickel contributes to the maintenance and improvement of the capacitance of the cathode active material. Therefore, according to nickel Ni, such a condition that it selectively and concentratedly exists in the surface is not so indispensable as compared with manganese Mn.

In the cathode active material in which the composite oxide particle constructed mainly by cobalt Co has been coated with the metal oxide constructed mainly by the oxide which contains lithium Li and the element of one of nickel Ni, manganese Mn, and cobalt Co, concentration distribution of nickel Ni, manganese Mn, and cobalt Co extending from the surface of the cathode active material particle to its inside is formed through the manufacturing processes of the cathode active material, particularly, the coating process of the compounds of nickel Ni and manganese Mn onto the composite oxide particle surface and the process for heat-processing the coated substance, heat-decomposing the coated compound, subsequently, diffusing nickel Ni and manganese Mn into the particle, and diffusing cobalt Co to the outside of the particle. By properly and effectively using the above processes, the concentration requirement can be accomplished.

The composite oxide particle contains at least lithium Li and cobalt Co and it is preferable that its mean compositions are expressed by, for example, Formula 1. This is because the high capacitance and the high discharge electric potential can be obtained by using such a composite oxide particle.

Formula 1

Li₍₁₊ₓ₎Co_{(1-y)}M_{y}O_{(2-z)}

in Formula 1, M denotes an element (elements) of one or more kinds selected from a group containing magnesium Mg, aluminum Al, boron B, titanium Ti, vanadium V, chromium Cr, manganese Mn, iron Fe, nickel Ni, copper Cu, zinc Zn, molybdenum Mo, tin Sn, and tungsten W; x indicates a value within a range of −0.10≦x≦0.10; y indicates a value within a range of 0≦y≦0.50; and z indicates a value within a range of −0.10≦z≦0.20.

In Formula 1, the range of x is, for example, −0.10≦x≦0.10, preferably, −0.08≦x≦0.08, and much preferably, −0.06≦x≦0.06. If x decreases to a value under such a range, the discharge capacitance decreases. If x increases to a value over such a range, the elements are diffused out of the particle, become an obstacle to control of basicity in a next processing step, and finally, become a cause of obstructing the promotion of a gel creation during the kneading of a cathode paste.

The range of y is, for example, 0≦y≦0.50, preferably, 0≦y≦0.40, and much preferably, 0≦y≦0.30. If y increases to a value over such a range, the high charge voltage performance held by LiCoO₂ and the high energy density performance associated therewith are deteriorated.

The range of z is, for example, −0.10≦z≦0.20, preferably, −0.08≦z≦0.18, and much preferably, −0.06≦z≦0.16. If z decreases to a value under such a range and if z increases to a value over such a range, there is such a tendency that the discharge capacitance decreases.

As for the composite oxide particle, a material which can be ordinarily obtained as a cathode active material can be used as a starting raw material. However, according to circumstances, after a secondary particle was broken by using a ball mill, a grinding machine, or the like, it can be used.

A coating layer is provided in at least a part of the composite oxide particle and has an oxide containing lithium Li and an element of at least one of nickel Ni, manganese Mn, and cobalt Co. By providing the coating layer, the high charge voltage performance and the high energy density performance associated therewith can be realized and the charge/discharge cycle characteristics at the high capacitance under the high charge voltage condition can be improved.

It is preferable that a construction ratio (Ni:Mn) of nickel Ni to manganese Mn in the coating layer lies within a range from 99:1 to 30:70 as a mole ratio. It is much preferable that it lies within a range from 98:2 to 40:60. This is because if an amount of manganese Mn increases to a value over such a range, doping performance of lithium Li deteriorates and, finally, it becomes a factor of a decrease in capacitance of the cathode active material and an increase in electric resistance when such a material is used for a battery.

Nickel Ni and manganese Mn in the oxide of the coating layer can be replaced by a metal element of at least one kind selected from a group containing magnesium Mg, aluminum Al, boron B, titanium Ti, vanadium V, chromium Cr, iron Fe, cobalt Co, copper Cu, zinc Zn, molybdenum Mo, tin Sn, and tungsten W.

Thus, stability of the cathode active material can be improved and diffusibility of lithium ions can be improved. A replacement amount of the selected metal element is, for example, equal to or less than 40 mol % of a total amount of nickel Ni and manganese Mn in the oxide of the coating layer, preferably, 30 mol % or less and, much preferably, 20 mol % or less. This is because if the replacement amount of the selected metal element increases to a value over such a range, the doping performance of lithium Li deteriorates and the capacitance of the cathode active material decreases.

An amount of coating layer lies, for example, within a range from 0.5 weight % to 50 weight % of the composite oxide particle, preferably, a range from 1.0 weight % to 40 weight %, much preferably, a range from 2.0 weight % to 35 weight %. This is because if the weight of the coating layer increases to a value over such a range, the capacitance of the cathode active material decreases. This is also because if the weight of the coating layer decreases to a value under such a range, the stability of the cathode active material deteriorates.

A mean diameter of the particle in the cathode active material preferably lies within a range from 2.0 μm to 50 μm. This is because if the mean diameter is less than 2.0 μm, when the cathode active material is pressed upon manufacturing of the cathode, it is peeled off and a surface area of the active material increases, so that it is necessary to increase addition amounts of a conductive material and a binder, and there is such a tendency that an energy density per unit weight decreases. This is also because if the mean diameter exceeds 50 μm, the particle pierces a separator and there is such a tendency that a short-circuit is caused.

Subsequently, a manufacturing method of the cathode active material according to the first embodiment will be described. The manufacturing method of the cathode active material according to the embodiment can be roughly classified into: a first step of forming a layer containing a hydroxide of nickel Ni and/or a hydroxide of manganese Mn into at least a part of the composite oxide particle; and a second step of heat-processing the composite oxide particle formed with the layer, thereby forming a coating layer having an oxide containing lithium Li and an element of at least one of nickel Ni, manganese Mn, and cobalt Co into at least a part of the composite oxide particle. In the composite oxide particle formed with the coating layer, the ratio [Ni(T)Co(S)/Ni(S)Co(T)] of the atomic ratio [Ni(T)/Co(T)] of nickel Ni to cobalt Co as an average of the whole cathode active material to the atomic ratio [Ni(S)/Co(S)] of nickel Ni to cobalt Co in the surface of the cathode active material is larger than the ratio [Mn(T)Co(S)/Mn(S)Co(T)] of the atomic ratio [Mn(T)/Co(T)] of manganese Mn to cobalt Co as an average of the whole cathode active material to the atomic ratio [Mn(S)/Co(S)] of manganese Mn to cobalt Co in the surface of the cathode active material.

In the first step, a coating process of the hydroxide containing the hydroxide of nickel Ni and/or the hydroxide of manganese Mn is executed. In the first step, for example, first, the composite oxide particle is dispersed into a solvent system constructed mainly by water in which a compound of nickel Ni and/or a compound of manganese Mn have been dissolved, a basicity of the dispersing system is raised by adding a base into the dispersing system, or the like, and the hydroxide of nickel Ni and/or the hydroxide of manganese Mn is precipitated to the surface of the composite oxide particle. It is also possible to use a method whereby the composite oxide particle is dispersed into the solvent constructed mainly by basic water, subsequently, the compound of nickel Ni and/or the compound of manganese Mn is added to the aqueous solution, and the hydroxide of nickel Ni and/or the hydroxide of manganese Mn is precipitated.

As for a raw material of the coating process of the hydroxide containing nickel Ni, as a nickel compound, for example, it is possible to use: an inorganic compound such as nickel hydroxide, nickel carbonate, nickel nitrate, nickel fluoride, nickel chloride, nickel bromide, nickel iodide, nickel perchlorate, nickel bromate, nickel iodate, nickel oxide, nickel peroxide, nickel sulfide, nickel sulfate, nickel hydrogensulfate, nickel nitride, nickel nitrite, nickel phosphate, nickel thiocyanate, or the like; or an organic compound such as nickel oxalate, nickel acetate, or the like. One, two, or more kinds of them may be used.

As for a raw material of the coating process of the hydroxide containing manganese Mn, as a manganese compound, for example, it is possible to use: an inorganic compound such as manganese hydroxide, manganese carbonate, manganese nitrate, manganese fluoride, manganese chloride, manganese bromide, manganese iodide, manganese chlorate, manganese perchlorate, manganese bromate, manganese iodate, manganese oxide, manganese phosphinate, manganese sulfide, manganese hydrogensulfide, manganese sulfate, manganese hydrogensulfate, manganese thiocyanate, manganese nitrite, manganese phosphate, manganese dihydrogenphosphate, manganese hydrogencarbonate, or the like; or an organic compound such as manganese oxalate, manganese acetate, or the like. One, two, or more kinds of them may be used.

A value of pH of the solvent system constructed mainly by the water mentioned above is, for example, equal to 12 or more, preferably, 13 or more, and much preferably, 14 or more. The larger the value of pH of the solvent system constructed mainly by the water mentioned above is, the better the uniformity of the coating of the hydroxide of nickel Ni and/or the hydroxide of manganese Mn is and the higher a reaction precision is. There are such advantages that the productivity is improved owing to the reduction in processing time and the quality is improved. The pH of the solvent system constructed mainly by the water is determined in consideration of the costs of alkali which is used or the like.

A temperature of the process dispersing system is, for example, equal to 40° C. or more, preferably, 60° C. or more, and much preferably, 80° C. or more. The larger the value of the temperature of the process dispersing system is, the better the uniformity of the coating of the hydroxide of nickel Ni and/or the hydroxide of manganese Mn is and the water a reaction speed is. There are such advantages that the productivity is improved owing to the reduction in processing time and the quality is improved. The value of the temperature of the process dispersing system is determined in consideration of the costs of the apparatus and the productivity. However, it is also possible to recommend to execute the processes at 100° C. or more by using an autoclave from a viewpoint of the productivity due to the reduction in processing time owing to the improvement of the coating uniformity and the improvement of the reaction speed.

Further, the pH of the solvent system constructed mainly by the water can be accomplished by dissolving alkali into the solvent system constructed mainly by the water. As alkali, for example, lithium hydroxide, sodium hydroxide, potassium hydroxide, and their mixture can be mentioned. Although the solvent system can be embodied by properly using those alkali, it is excellent to use lithium hydroxide from viewpoints of purity and performance of the cathode active material according to the embodiment which is finally obtained. This is because if lithium hydroxide is used, the following advantages are obtained. When the composite oxide particle formed with the layer containing the hydroxide of nickel Ni and/or the hydroxide of manganese Mn is taken out of the solvent system constructed mainly by the water, by controlling a deposition amount of the dispersing medium made of the solvent constructed mainly by the water, an amount of lithium of the cathode active material according to the embodiment which is finally obtained can be controlled.

In the second step, the composite oxide particle which has been coating-processed in the first step is separated from the solvent system constructed mainly by the water and, thereafter, heat-processed, thereby dehydrating the hydroxide. A coating layer having an oxide containing lithium Li and an element of at least one of nickel Ni, manganese Mn, and cobalt Co is formed on the surface of the composite oxide particle. It is preferable that the heating process is executed in an oxidation atmosphere such as air, pure oxygen, or the like at temperatures of, for example, about 300° C. to 1000° C.

After the composite oxide particle which has been coating-processed in the first step was separated from the solvent system, if necessary, in order to adjust the lithium amount, it is also possible to impregnate an aqueous solution of the lithium compound into the composite oxide particle and, thereafter, execute the heating process.

As a lithium compound, for example, it is possible to use: an inorganic compound such as lithium hydroxide, lithium carbonate, lithium nitrate, lithium fluoride, lithium chloride, lithium bromide, lithium iodide, lithium chlorate, lithium perchlorate, lithium bromate, lithium iodate, lithium oxide, lithium peroxide, lithium sulfide, lithium hydrogensulfide, lithium sulfate, lithium hydrogensulfate, lithium nitride, lithium azide, lithium nitrite, lithium phosphate, lithium dihydrogenphosphate, lithium hydrogencarbonate, or the like; or an organic compound such as methyllithium, vinyllithium, isopropyl lithium, butyllithium, phenyllithium, lithium oxalate, lithium acetate, or the like.

After the baking, a particle size can be also adjusted as necessary by light pulverization, the classifying operation, or the like.

A non-aqueous electrolyte secondary battery, using the foregoing cathode active material will now be described. The foregoing cathode active material is preferably used as an electrode active material as mentioned above, particularly, it is preferably used in an electrode for the non-aqueous electrolyte secondary battery and the non-aqueous electrolyte secondary battery.

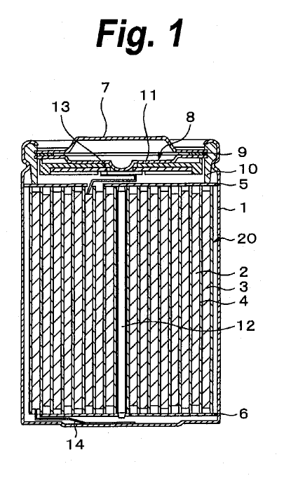

FIG. 1 shows a cross sectional structure of the first example of the non-aqueous electrolyte secondary battery using the cathode active material mentioned above.

In the secondary battery, an open circuit voltage in a perfect charging state per pair of cathode and anode lies within a range, for example, from 4.25V or more to 4.65V or less.

The secondary battery is what is called a cylindrical type and has a winded electrode member 20 in which a belt-shaped cathode 2 and a belt-shaped anode 3 have been wound through a separator 4 in an almost hollow cylindrical battery can 1.

The battery can 1 is made of iron Fe plated with, for example, nickel Ni. One end portion of the battery can is closed and the other end portion is open. A pair of insulating plates 5 and 6 are arranged in the battery can 1 so as to be perpendicular to the winded peripheral surface so as to sandwich the winded electrode member 20, respectively.

A battery cap 7 and a relief valve mechanism 8 and a thermally-sensitive resistive (PTC: Positive Temperature Coefficient) element 9 which are provided in the battery cap 7 are attached to the open end portion of the battery can 1 by being caulked through a gasket 10. The inside of the battery can 1 is sealed. The battery cap 7 is made of, for example, a material similar to that of the battery can 1. The relief valve mechanism 8 is electrically connected to the battery cap 7 through the PTC element 9. When an inner pressure of the battery rises to a predetermined value or more by an internal short-circuit, heating from the outside, or the like, a disk plate 11 is reversed, thereby disconnecting the electric connection between the battery cap 7 and the winded electrode member 20. When a temperature rises, the PTC element 9 limits a current by an increase in resistance value, thereby preventing an abnormal heat generation that is caused by the large current. The gasket 10 is made of, for example, an insulating material and its surface is coated with asphalt.

The winded electrode member 20 is wound around, for example, a center pin 12 as a center. A cathode lead 13 made of, for example, aluminum Al or the like is connected to the cathode 2 of the winded electrode member 20. An anode lead 14 made of, for example, nickel Ni or the like is connected to the anode 3. The cathode lead 13 is welded to the relief valve mechanism 8, so that it is electrically connected to the battery cap 7. The anode lead 14 is welded to the battery can 1 and is electrically connected thereto.

[Cathode]

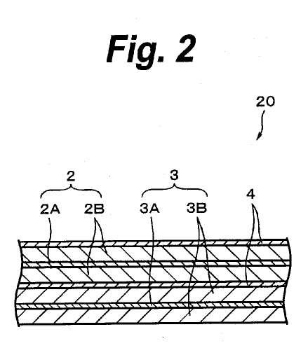

FIG. 2 enlargedly shows a part of the winded electrode member 20 shown in FIG. 1. As shown in FIG. 2, the cathode 2 has, for example, a cathode collector 2A having a pair of opposite surfaces and cathode mixture layers 2B provided for the both surfaces of the cathode collector 2A. The cathode 2 may have a region where the cathode mixture layer 2B is provided only for one surface of the cathode collector 2A. The cathode collector 2A is made of, for example, a metal foil such as an aluminum Al foil or the like. The cathode mixture layer 2B contains, for example, a cathode active material and may contain a conductive material such as graphite or the like and a binder such as polyvinylidene fluoride or the like as necessary. As a cathode active material, the foregoing cathode active material can be used.

[Anode]

As shown in FIG. 2, the anode 3 has, for example, an anode collector 3A having a pair of opposite surfaces and anode mixture layers 3B provided for the both surfaces of the anode collector 3A. The anode 3 may have a region where the anode mixture layer 3B is provided only for one surface of the anode collector 3A. The anode collector 3A is made of, for example, a metal foil such as a copper Cu foil or the like. The anode mixture layer 3B contains, for example, an anode active material and may contain a binder such as polyvinylidene fluoride or the like as necessary.

As an anode active material, an anode material which can dope and dedope lithium Li (hereinbelow, properly called an anode material which can dope and dedope lithium Li) is contained. As an anode material which can dope and dedope lithium Li, for example, a carbon material, a metal compound, an oxide, a sulfide, a lithium nitride such as LiN₃ or the like, a lithium metal, a metal which forms an alloy together with lithium, a high molecular material, or the like can be mentioned. Among them, as an anode active material, a carbonaceous material is preferably used. When an electron conductivity of the carbonaceous material is not enough to collect, it is also preferable to add a conductive material.

As a carbon material, for example, non-easy-graphitizable carbon, easy-graphitizable carbon, graphite, a pyrolytic carbon class, a coke class, a glassy carbon class, an organic high molecular compound baked material, carbon fiber, or activated charcoal can be mentioned. Among them, there is a pitch coke, a needle coke, a petroleum coke, or the like as a coke class. The organic high molecular compound baked material denotes a material obtained by baking the high molecular material such as phenol resin, fran resin, or the like at a proper temperature and carbonating it. A part of those materials are classified into the non-easy-graphitizable carbon or the easy-graphitizable carbon. Polyacetylene, polypyrrole, or the like can be mentioned as a high molecular material.

Among those anode materials which can dope and dedope lithium Li, a material whose charge/discharge electric potential is relatively close to that of the lithium metal is preferable. This is because the lower the charge/discharge electric potential of the anode 3 is, the more the high energy density performance of the battery can be easily realized. Among them, the carbon material is preferable because a change in crystal structure which is caused upon charging or discharging is very small, a high charge/discharge capacitance can be obtained, and good cycle characteristics can be obtained. Particularly, the graphite is preferable because an electrochemical equivalent is large and the high energy density performance can be obtained. The non-easy-graphitizable carbon is preferable because the excellent cycle characteristics can be obtained.

As an anode material which can dope and dedope lithium Li, a lithium metal simple substance or a simple substance, an alloy, or a compound of a metal element or a semimetal element which can form an alloy together with lithium Li can be mentioned. Those materials are preferable because the high energy density performance can be obtained. Particularly, if it is used together with a carbon material, since the high energy density performance can be obtained and the excellent cycle characteristics can be obtained, it is much preferable. In the specification, in addition to the alloy made of two or more kinds of metal elements, an alloy made of one or more kinds of metal elements and one or more kinds of semimetal elements is also incorporated as an alloy. As its texture, there is a solid solution, an eutectic (eutectic mixture), an intermetallic compound, or a texture in which two or more kinds of them coexists.

As such a metal element or a semimetal element, for example, tin Sn, lead Pb, aluminum Al, indium In, silicon Si, zinc Zn, antimony Sb, bismuth Bi, cadmium Cd, magnesium Mg, boron B, gallium Ga, germanium Ge, arsenic As, silver Ag, zirconium Zr, yttrium Y, or hafnium Hf can be mentioned. As an alloy or a compound of them, for example, an alloy or a compound expressed by Formula MaₛMbₜLiᵤ or MaₚMc_{q}Mdᵣ can be mentioned. In those Formulae, Ma indicates at least one kind of metal elements and semimetal elements which can form an alloy together with lithium; Mb indicates at least one kind of the metal elements and the semimetal elements other than lithium and Ma; Mc indicates at least one kind of the nonmetal elements; and Md indicates at least one kind of the metal elements and the semimetal elements other than Ma; s indicates a value of s>0; t indicates a value of t≧0; u indicates a value of u≧0; p indicates a value of p>0; q indicates a value of q>0; and r indicates a value of r≧0.

Among them, a simple substance, an alloy, or a compound of a metal element or a semimetal element of Group 4B in a short period type periodic table is preferable. Silicon Si, tin Sn, or an alloy or a compound of them is particularly preferable. They may be either crystalline or amorphous.

Besides them, an inorganic compound such as MnO₂, V₂O₅, V₆O₁₃, NiS, MoS, or the like which does not contain lithium Li can be also used.

[Electrolytic Solution]

As an electrolytic solution, a non-aqueous electrolytic solution obtained by dissolving an electrolytic salt into a non-aqueous solvent can be used. As a non-aqueous solvent, it is preferable to contain at least one of, for example, ethylene carbonate and propylene carbonate. This is because the cycle characteristics can be improved. Particularly, if ethylene carbonate and propylene carbonate are mixed and contained, it is preferable because the cycle characteristics can be further improved. As a non-aqueous solvent, it is preferable to contain at least one kind selected from chain-like carbonic esters such as diethyl carbonate, dimethyl carbonate, ethylmethyl carbonate, methylpropyl carbonate, and the like. This is because the cycle characteristics can be further improved.

Further, as a non-aqueous solvent, it is preferable to contain at least one of 2,4-difluoroanisole and vinylene carbonate. This is because in the case of 2,4-difluoroanisole, the discharge capacitance can be improved and in the case of vinylene carbonate, the cycle characteristics can be further improved. Particularly, if they are mixed and contained, it is much preferable because both of the discharge capacitance and the cycle characteristics can be improved.

As a non-aqueous solvent, it is also possible to contain one, two, or more kinds of the following materials: butylene carbonate; γ-butyrolactone; γ-valerolactone; a compound in which a part or all of a hydrogen radical of those compounds has been replaced by a fluorine radical; 1,2-dimethoxy ethane; tetrahydrofuran; 2-methyl tetrahydrofuran; 1,3-dioxorane; 4-methyl-1,3-dioxorane; methyl acetate; methyl propionate; acetonitrile; glutaronitrile; adiponitrile; methoxy acetonitrile; 3-methoxy propylonitrile; N,N-dimethyl formamide; N-methyl pyrrolidinone; N-methyl oxazolidinone; N,N-dimethyl imidazolidinone; nitromethane; nitroethane; sulfolan; dimethyl sulfoxide; trimethyl phosphate; and the like.

In dependence on the kind of electrode which is combined, there is also a case where by using the compound in which a part or all of hydrogen atoms of a substance contained in the above non-aqueous solvent group has been replaced by fluorine atoms, the reversibility of the electrode reaction is improved. Therefore, those substances can be also properly used.

As a lithium salt as an electrolytic salt, for example, it is proper to use LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, LiBF_{2(OX)}, LIBOB, or LiBr. One, two, or more kinds of them can be also mixed and used. Among them, LiPF₆ is preferable because the high ion conductivity can be obtained and the cycle characteristics can be improved.

[Separator]

A separator material which can be used in the embodiment will be described hereinbelow. As a separator material which is used for the separator 4, materials used in the battery in the related art can be used. Among them, it is particularly preferable to use a microporous film made of polyolefin which has an excellent short-circuit preventing effect and can improve the safety of the battery owing to a shut-down effect. For example, a microporous membrane made of polyethylene or polypropylene resin is preferable.

Further, as a separator material, it is much preferable to use a microporous film obtained by laminating or mixing polyethylene whose shut-down temperature is lower and polypropylene having excellent oxidation resistance from a viewpoint that both of shut-down performance and floating characteristics can be satisfied.

A manufacturing method of the non-aqueous electrolyte secondary battery will now be described. A cylindrical non-aqueous electrolyte secondary battery is mentioned as an example and the manufacturing method of the non-aqueous electrolyte secondary battery will be described hereinbelow.

The cathode 2 is manufactured as follows. First, for example, by mixing the cathode active material, conductive material, and binder, the cathode mixture is adjusted. The cathode mixture is dispersed into the solvent such as N-methyl-2-pyrrolidone or the like, thereby forming the cathode mixture slurry. Since the manufacturing method of the cathode active material has been mentioned above, its detailed description is omitted here.

Subsequently, the cathode collector 2A is coated with the cathode mixture slurry, the solvent is dried, thereafter, the obtained collector is compression-molded by a roll pressing machine or the like, and the cathode mixture layer 2B is formed, thereby manufacturing the cathode 2.

The anode 3 is manufactured as follows. First, for example, by mixing the anode active material and binder, the anode mixture is adjusted. The anode mixture is dispersed into the solvent such as N-methyl-2-pyrrolidone or the like, thereby forming the anode mixture slurry.

Subsequently, the anode collector 3A is coated with the anode mixture slurry, the solvent is dried, thereafter, the obtained collector is compression-molded by the roll pressing machine or the like, and the anode mixture layer 3B is formed, thereby manufacturing the anode 3.

The anode mixture layer 3B may be formed by, for example, a vapor phase method, a liquid phase method, or a baking method. Two or more kinds of them can be also combined. As a vapor phase method, for example, a physical depositing method or a chemical depositing method can be used. Specifically speaking, it is possible to use a vacuum evaporation depositing method, a sputtering method, an ion plating method, a laser ablation method, a thermal CVD (Chemical Vapor Deposition) method, a plasma CVD method, or the like. As a liquid phase method, a well-known method such as electroplating, an electroless plating, or the like can be used. As a baking method, a well-known method can be also used. For example, an atmosphere baking method, a reaction baking method, or a hot press baking method can be used.

Subsequently, the cathode lead 13 is attached to the cathode collector 2A by welding or the like and the anode lead 14 is attached to the anode collector 3A by welding or the like. Thereafter, the cathode 2 and the anode 3 are wound through the separator 4, a front end portion of the cathode lead 13 is welded to the relief valve mechanism 8, a front end portion of the anode lead 14 is welded to the battery can 1, and the wound cathode 2 and anode 3 are sandwiched by the pair of insulating plates 5 and 6 and enclosed in the battery can 1.

Subsequently, the electrolytic solution is injected into the battery can 1 and impregnated into the separator 4. Thereafter, the battery cap 7, relief valve mechanism 8, and PTC element 9 are caulked and fixed to the open end portion of the battery can 1 through the gasket 10. Thus, the non-aqueous electrolyte secondary battery is manufactured.

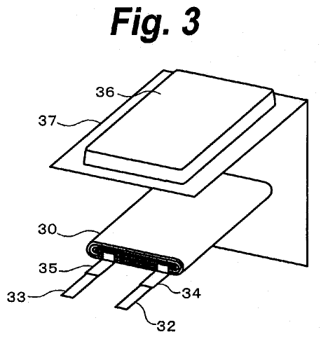

A second example of the non-aqueous electrolyte secondary battery using the foregoing cathode active material will now be described. FIG. 3 shows a structure of the second example of the non-aqueous electrolyte secondary battery using the foregoing cathode active material. As shown in FIG. 3, this non-aqueous electrolyte secondary battery is formed in such a manner that a battery element 30 is enclosed into a sheathing member 37 made of a moisture-proof laminate film and a circumference of the battery element 30 is meld-bonded, thereby sealing the battery. A cathode lead 32 and an anode lead 33 are provided for the battery element 30. Those leads are sandwiched between the sheathing members 37 and are led out to the outside. Both surfaces of the cathode lead 32 are coated with resin members 34 and both surfaces of the anode lead 33 are coated with resin members 35 in order to improve adhesion with the sheathing members 37, respectively.

[Sheathing Member]

The sheathing member 37 has a laminate structure obtained by sequentially laminating, for example, an adhesive layer, a metal layer, and a surface protecting layer. The adhesive layer is made of a high molecular film. As a material constructing the high molecular film, for example, polypropylene PP, polyethylene PE, casted polypropylene (non-oriented polypropylene) CPP, linear low-density polyethylene LLDPE, or low-density polyethylene LDPE can be mentioned. The metal layer is made of a metal foil. As a material constructing the metal foil, for example, aluminum Al can be mentioned. As a material constructing the metal foil, for example, a metal other than aluminum Al can be also used. As a material constructing the surface protecting layer, for example, nylon Ny, or polyethylene terephthalate PET can be mentioned. The surface of the adhesive layer side becomes an enclosing surface of the side where the battery element 30 is enclosed.

[Battery Element]

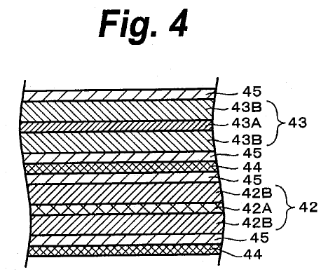

For example, as shown in FIG. 4, the battery element 30 is a winding type battery element 30 constructed in such a manner that a belt-shaped anode 43 provided with gel electrolyte layers 45 on both sides, a separator 44, a belt-shaped cathode 42 provided with the gel electrolyte layers 45 on both sides, and the separator 44 are laminated and wound in the longitudinal direction.

The cathode 42 is constructed by a belt-shaped cathode collector 42A and cathode mixture layers 42B formed on both surfaces of the cathode collector 42A.

The cathode lead 32 connected by, for example, spot welding or ultrasonic welding is provided for one end portion in the longitudinal direction of the cathode 42. As a material of the cathode lead 32, for example, a metal such as aluminum or the like can be used.

The anode 43 is constructed by a belt-shaped anode collector 43A and anode mixture layers 43B formed on both surfaces of the anode collector 43A.

The anode lead 33 connected by, for example, the spot welding or ultrasonic welding is also provided for one end portion in the longitudinal direction of the anode 43 in a manner similar to the cathode 42. As a material of the anode lead 33, for example, copper Cu, nickel Ni, or the like can be used.

The cathode collector 42A, cathode mixture layers 42B, anode collector 43A, and anode mixture layers 43B are similar to those in the foregoing first example.

The gel electrolyte layer 45 contains an electrolytic solution and a high molecular compound serving as a holding member to hold the electrolytic solution and is in what is called a gel state. The gel electrolyte layer 45 is preferable because the high ion conductivity can be obtained and a leakage of a solution in the battery can be prevented. A construction of the electrolytic solution (that is, a liquid solvent and electrolytic salt) is similar to that in the first example.

As a high molecular compound, for example, there can be mentioned: polyacrylonitrile; polyvinylidene fluoride; copolymer of vinylidene fluoride and hexafluoro propylene; polytetrafluoro ethylene; polyhexafluoro propylene; polyethylene oxide; polypropylene oxide; polyphosphazene; polysiloxane; polyvinyl acetate; polyvinyl alcohol; polymethyl methacrylate; polyacrylic acid; polymethacrylate; styrene-butadiene rubber; nitrile-butadiene rubber; polystyrene; or polycarbonate. Particularly, from a viewpoint of electrochemical stability, polyacrylonitrile, polyvinylidene fluoride, polyhexafluoro propylene, or polyethylene oxide is preferable.

A manufacturing method of the second example of the non-aqueous electrolyte secondary battery using the foregoing cathode active material will now be described. First, each of the cathode 42 and the anode 43 is coated with a presolution containing a solvent, electrolytic salt, a high molecular compound and a mixed solvent, and the mixed solvent is volatilized, thereby forming the gel electrolyte layer 45. The cathode lead 32 is preliminarily attached to an end portion of the cathode collector 42A by welding. The anode lead 33 is also preliminarily attached to an end portion of the anode collector 43A by welding.

Subsequently, the cathode 42 and anode 43 on each of which the gel electrolyte layer 45 has been formed are laminated through the separator 44, thereby obtaining a laminate. After that, this laminate is wound in its longitudinal direction, thereby forming the winding type battery element 30.

Then, a concave portion 36 is formed by deep-drawing the sheathing member 37 made of a laminate film. The battery element 30 is inserted into the concave portion 36. An unprocessed portion of the sheathing member 37 is folded to an upper portion of the concave portion 36 and an outer peripheral portion of the concave portion 36 is thermally melt-bonded, thereby sealing. In this manner, the non-aqueous electrolyte secondary battery is manufactured.

### EXAMPLES

Specific Examples of the application will be described hereinbelow. The application is not limited to them.

### Example 1

First, lithium cobalt acid of 20 weight parts in which analysis values of mean chemical composition are Li_{1.03}CO_{0.98}Al_{0.01}Mg_{0.01}O_{2.02} and a mean diameter measured by a laser scattering method is equal to 13 μm is stirred and dispersed into the pure water of 80° C. and 300 weight parts for 1 hour.

Subsequently, nickel nitrate Ni(NO₃)₂.6H₂O of 1.85 weight parts as a commercially available chemical reagent and manganese nitrate Mn(NO₃)₂.6H₂O of 1.83 weight parts as a commercially available chemical reagent are added to the obtained solution. An LiOH aqueous solution of 2N is further added for 30 minutes until the value of pH reaches 13. The agitation-dispersion is further continued at 80° C. for 3 hours and, thereafter, the obtained solution is cooled.

Subsequently, the above dispersing system is decantation-cleaned and dried at 120° C., thereby obtaining a precursor sample in which a hydroxide has been formed on the surface. Subsequently, in order to adjust an amount of lithium, an LiOH aqueous solution of 2N of 2 weight parts is impregnated into the obtained precursor sample of 10 weight parts and uniformly mixed and the obtained sample is dried, thereby obtaining a baked precursor. The baked precursor is temperature-elevated at a rate of 5° C. per minute by using an electric furnace, held at 900° C. for 8 hours, and thereafter, cooled down to 150° C. at a rate of 7° C. per minute, thereby obtaining a cathode active material of Example 1.

The cathode active material of Example 1 is quantified by using the XPS and ICP-AES. An atomic ratio [Ni(T)/Co(T)] of nickel Ni to cobalt Co as an average of the whole cathode active material, an atomic ratio [Ni(S)/Co(S)] of nickel Ni to cobalt Co in the surface of the cathode active material, and a ratio [Ni(T)Co(S)/Ni(S)Co(T)] of the atomic ratio [Ni(T)/Co(T)] to the atomic ratio [Ni(S)/Co(S)] are calculated.

An atomic ratio [Mn(T)/Co(T)] of manganese Mn to cobalt Co as an average of the whole cathode active material, an atomic ratio [Mn(S)/Co(S)] of manganese Mn to cobalt Co in the surface of the cathode active material, and a ratio [Mn(T)Co(S)/Mn(S)Co(T)] of the atomic ratio [Mn(T)/Co(T)] to the atomic ratio [Mn(S)/Co(S)] are calculated.

Thus, the atomic ratio [Ni(T)/Co(T)] of nickel Ni to cobalt Co as an average of the whole cathode active material is equal to 0.048. The atomic ratio [Ni(S)/Co(S)] of nickel Ni to cobalt Co in the surface of the cathode active material is equal to 0.93. The ratio [Ni(T)Co(S)/Ni(S)Co(T)] is equal to 0.052.

The atomic ratio [Mn(T)/Co(T)] of manganese Mn to cobalt Co as an average of the whole cathode active material is equal to 0.048. The atomic ratio [Mn(S)/Co(S)] of manganese Mn to cobalt Co in the surface of the cathode active material is equal to 1.37. The ratio [Mn(T)Co(S)/Mn(S)Co(T)] is equal to 0.035.

### Example 2

First, the lithium cobalt acid of 20 weight parts used in Example 1 is stirred and dispersed into the LiOH aqueous solution of 80° C., 2N, and 300 weight parts. Subsequently, an aqueous solution of 10 weight parts is formed by adding the pure water to nickel nitrate Ni(NO₃)₂6H₂O of 0.927 weight part as a commercially available chemical reagent and manganese nitrate Mn(NO₃)₂.6H₂O of 0.915 weight part as a commercially available chemical reagent similar to those in Example 1. The whole amount of the aqueous solution of 10 weight parts is added to the obtained solution for 30 minutes. The agitation-dispersion is further continued at 80° C. for 3 hours and, thereafter, the obtained solution is cooled.

Subsequently, the above dispersing system is filtered and dried at 120° C., thereby obtaining a precursor sample in which a hydroxide has been formed on the surface. Subsequently, the precursor sample is temperature-elevated at a rate of 5° C. per minute by using the electric furnace, held at 950° C. for 8 hours, and thereafter, cooled down to 150° C. at a rate of 7° C. per minute, thereby obtaining a cathode active material of Example 2.

The cathode active material of Example 2 is quantified by using the XPS and ICP-AES. An atomic ratio [Ni(T)/Co(T)] of nickel Ni to cobalt Co as an average of the whole cathode active material, an atomic ratio [Ni(S)/Co(S)] of nickel Ni to cobalt Co in the surface of the cathode active material, and a ratio [Ni(T)Co(S)/Ni(S)Co(T)] of the atomic ratio [Ni(T)/Co(T)] to the atomic ratio [Ni(S)/Co(S)] are calculated.

An atomic ratio [Mn(T)/Co(T)] of manganese Mn to cobalt Co as an average of the whole cathode active material, an atomic ratio [Mn(S)/Co(S)] of manganese Mn to cobalt Co in the surface of the cathode active material, and a ratio [Mn(T)Co(S)/Mn(S)Co(T)] of the atomic ratio [Mn(T)/Co(T)] to the atomic ratio [Mn(S)/Co(S)] are calculated.

Thus, the atomic ratio [Ni(T)/Co(T)] of nickel Ni to cobalt Co as an average of the whole cathode active material is equal to 0.024. The atomic ratio [Ni(S)/Co(S)] of nickel Ni to cobalt Co in the surface of the cathode active material is equal to 0.25. The ratio [Ni(T)Co(S)/Ni(S)Co(T)] is equal to 0.096.

The atomic ratio [Mn(T)/Co(T)] of manganese Mn to cobalt Co as an average of the whole cathode active material is equal to 0.024. The atomic ratio [Mn(S)/Co(S)] of manganese Mn to cobalt Co in the surface of the cathode active material is equal to 0.58. The ratio [Mn(T)Co(S)/Mn(S)Co(T)] is equal to 0.041.

### Example 3

Each of a weight of nickel nitrate Ni(NO₃)₂.6H₂O and a weight of manganese nitrate Mn(NO₃)₂.6H₂O in Example 2 is doubled. That is, an aqueous solution of 10 weight parts is formed by adding the pure water to nickel nitrate Ni(NO₃)₂.6H₂O of 1.39 weight parts and manganese nitrate Mn(NO₃)₂.6H₂O of 0.46 weight part. The whole amount of the aqueous solution of 10 weight parts is added to the obtained solution. Other processes are executed in a manner similar to those in Example 2, thereby obtaining a cathode active material of Example 3.

The cathode active material of Example 3 is quantified by using the XPS and ICP-AES. An atomic ratio [Ni(T)/Co(T)] of nickel Ni to cobalt Co as an average of the whole cathode active material, an atomic ratio [Ni(S)/Co(S)] of nickel Ni to cobalt Co in the surface of the cathode active material, and a ratio [Ni(T)Co(S)/Ni(S)Co(T)] of the atomic ratio [Ni(T)/Co(T)] to the atomic ratio [Ni(S)/Co(S)] are calculated.

An atomic ratio [Mn(T)/Co(T)] of manganese Mn to cobalt Co as an average of the whole cathode active material, an atomic ratio [Mn(S)/Co(S)] of manganese Mn to cobalt Co in the surface of the cathode active material, and a ratio [Mn(T)Co(S)/Mn(S)Co(T)] of the atomic ratio [Mn(T)/Co(T)] to the atomic ratio [Mn(S)/Co(S)] are calculated.

Thus, the atomic ratio [Ni(T)/Co(T)] of nickel Ni to cobalt Co as an average of the whole cathode active material is equal to 0.036. The atomic ratio [Ni(S)/Co(S)] of nickel Ni to cobalt Co in the surface of the cathode active material is equal to 0.86. The ratio [Ni(T)Co(S)/Ni(S)Co(T)] is equal to 0.042.

The atomic ratio [Mn(T)/Co(T)] of manganese Mn to cobalt Co as an average of the whole cathode active material is equal to 0.012. The atomic ratio [Mn(S)/Co(S)] of manganese Mn to cobalt Co in the surface of the cathode active material is equal to 0.42. The ratio [Mn(T)Co(S)/Mn(S)Co(T)] is equal to 0.029.

<Comparison 1>

The lithium cobalt acid which has been used in Example 1 and in which the analysis values of the mean chemical composition are Li_{1.03}Co_{0.98}Al_{0.01}Mg_{0.01}O_{2.02} and the mean diameter measured by the laser scattering method is equal to 13 μm is used as a cathode active material of Comparison 1.

<Comparison 2>

Lithium carbonate Li₂CO₃ of 38.1 weight parts as a commercially available chemical reagent, cobalt carbonate CoCO₃ of 116.5 weight parts as a commercially available chemical reagent, and manganese carbonate MnCO₃ of 2.3 weight parts as a commercially available chemical reagent are sufficiently mixed while being pulverized by a ball mill. Subsequently, the obtained mixture is temporarily baked in the air at 650° C. for 5 hours, further held in the air at 950° C. for 20 hours, and thereafter, cooled down to 150° C. at a rate of 7° C. per minute. Subsequently, the mixture is taken out at a room temperature and pulverized, thereby obtaining the composite oxide particle. According to this composite oxide particle, the mean diameter measured by the laser scattering method is equal to 12 μm and the analysis values of the mean chemical compositions are Li_{1.03}Co_{0.98}Mn_{0.02}O_{2.02}

Such a composite oxide particle of 20 weight parts is stirred and dispersed into the pure water of the LiOH aqueous solution of 80° C., 2N, and 300 weight parts for 2 hours. An aqueous solution of 10 weight parts is manufactured by adding the pure water to nickel nitrate Ni(NO₃)₂.6H₂O of 0.927 weight part as a commercially available chemical reagent and manganese nitrate Mn(NO₃)₂.6H₂O of 0.090 weight part as a commercially available chemical reagent which are similar to those in Example 1. The whole amount of the obtained aqueous solution of 11 weight parts is added to the obtained solution for 30 minutes. The agitation-dispersion is further continued at 80° C. for 3 hours and, thereafter, the obtained solution is cooled. Subsequently, the above dispersing system is filtered and dried at 120° C., thereby obtaining a precursor sample. Subsequently, the precursor sample is temperature-elevated at a rate of 5° C. per minute by using the electric furnace, held at 950° C. for 8 hours, and thereafter, cooled down to 150° C. at a rate of 7° C. per minute, thereby obtaining a cathode active material of Comparison 2.

The cathode active material of Example 2 is quantified by using the XPS and ICP-AES. An atomic ratio [Ni(T)/Co(T)] of nickel Ni to cobalt Co as an average of the whole cathode active material, an atomic ratio [Ni(S)/Co(S)] of nickel Ni to cobalt Co in the surface of the cathode active material, and a ratio [Ni(T)Co(S)/Ni(S)Co(T)] of the atomic ratio [Ni(T)/Co(T)] to the atomic ratio [Ni(S)/Co(S)] are calculated.

An atomic ratio [Mn(T)/Co(T)] of manganese Mn to cobalt Co as an average of the whole cathode active material, an atomic ratio [Mn(S)/Co(S)] of manganese Mn to cobalt Co in the surface of the cathode active material, and a ratio [Mn(T)Co(S)/Mn(S)Co(T)] of the atomic ratio [Mn(T)/Co(T)] to the atomic ratio [Mn(S)/Co(S)] are calculated.

Thus, the atomic ratio [Ni(T)/Co(T)] of nickel Ni to cobalt Co as an average of the whole cathode active material is equal to 0.024. The atomic ratio [Ni(S)/Co(S)] of nickel Ni to cobalt Co in the surface of the cathode active material is equal to 0.23. The ratio [Ni(T)Co(S)/Ni(S)Co(T)] is equal to 0.104.

The atomic ratio [Mn(T)/Co(T)] of manganese Mn to cobalt Co as an average of the whole cathode active material is equal to 0.042. The atomic ratio [Mn(S)/Co(S)] of manganese Mn to cobalt Co in the surface of the cathode active material is equal to 0.07. The ratio [Mn(T)Co(S)/Mn(S)Co(T)] is equal to 0.600.

(Evaluation)

The cylindrical batteries shown in FIGS. 1 and 2 are manufactured by using the manufactured cathode active materials of Examples 1 to 3 and Comparisons 1 and 2 and cycle characteristics at a high temperature are evaluated.

First, the cathode active material of 86 weight %, graphite of 10 weight % as a conductive material, and polyvinylidene fluoride PVdF of 4 weight % serving as a binder are mixed and dispersed into N-methyl-2-pyrrolidone NMP, thereby forming a cathode mixture slurry.

Subsequently, both surfaces of a belt-shaped aluminum foil having a thickness of 20 μm are uniformly coated with the cathode mixture slurry. The foil is dried and, thereafter, compression-molded by a roller pressing machine, thereby forming the belt-shaped cathode 2. At this time, a gap in the electrode is adjusted so as to reach 26% as a volume ratio. The cathode lead 13 made of aluminum is attached to the cathode collector 2A.

Powdery artificial graphite of 90 weight % serving as an anode active material and polyvinylidene fluoride PVdF of 10 weight % serving as a binder are mixed and dispersed into N-methyl-2-pyrrolidone NMP, thereby forming an anode mixture slurry.

Subsequently, both surfaces of a copper foil having a thickness of 10 μm are uniformly coated with the anode mixture slurry. The foil is dried and, thereafter, compression-molded by the roller pressing machine, thereby forming the belt-shaped anode 3. The anode lead 14 made of nickel is attached to the anode collector 3A.

The belt-shaped cathode 2 and the belt-shaped anode 3 manufactured as mentioned above are wound a number of times through a porous polyolefin film serving as a separator 4, thereby manufacturing the spiral type winded electrode member 20. Subsequently, the winded electrode member 20 is enclosed in the battery can 1 made of iron plated with nickel. The pair of insulating plates 5 and 6 are arranged on both of the upper and lower surfaces of the winded electrode member 20.

Subsequently, the cathode lead 13 made of aluminum is led out of the cathode collector 2A and welded to a projecting portion of the relief valve mechanism 8 whose electrical conduction with the battery cap 7 has been assured. The anode lead 14 made of nickel is led out of the anode collector 3A and welded to the bottom portion of the battery can 1.

Finally, after an electrolytic solution was injected into the battery can 1 in which the foregoing winded electrode member 20 has been built, the battery can 1 is caulked through the insulating sealing gasket 10, thereby fixing the relief valve mechanism 8, PTC element 9, and battery cap 7, so that the cylindrical battery having an outer diameter of 18 mm and a height of 65 mm is manufactured.

As an electrolytic solution, LiPF₆ is dissolved into a mixed solution in which a volume mixture ratio of ethylene carbonate to diethyl carbonate is equal to 1:1 and adjusted so as to obtain a concentration of 1.0 mol/dm³ and the obtained solution is used.

With respect to the non-aqueous electrolyte secondary battery manufactured as mentioned above, the charging is executed under conditions of a temperature environment of 45° C., a charge voltage of 4.40V, a charge current of 1000 mA, and a charging time of 2.5 hours. After that, the discharging is executed at a discharge current of 800 mA and a final voltage of 2.75V and an initial capacitance is measured.

The charging and discharging are repeated under conditions similar to those in the case of obtaining the initial capacitance. A discharge capacitance at the 200th cycle is measured and a capacitance maintaining ratio to the initial capacitance is obtained. Measurement results are shown in Table 1.

TABLE 1

| | | | Initial | Capacitance |
|---|---|---|---|---|
| | Ni(T)Co(S)/ | Mn(T)Co(S)/ | capacitance | maintaining |
| | Ni(S)Co(T) | Mn(S)Co(T) | [mAh] | ratio [%] |
| Example 1 | 0.052 | 0.035 | 2430 | 82 |
| Example 2 | 0.096 | 0.041 | 2450 | 82 |
| Example 3 | 0.042 | 0.029 | 2480 | 83 |
| Comparison 1 | — | — | 2450 | 35 |
| Comparison 2 | 0.104 | 0.600 | 2330 | 78 |

As shown in Table 1, according to Examples 1 to 3 in which the ratio [Ni(T)Co(S)/Ni(S)Co(T)] of the atomic ratio [Ni(T)/Co(T)] of nickel Ni to cobalt Co as an average of the whole cathode active material to the atomic ratio [Ni(S)/Co(S)] of nickel Ni to cobalt Co in the surface of the cathode active material is larger than the ratio [Mn(T)Co(S)/Mn(S)Co(T)] of the atomic ratio [Mn(T)/Co(T)] of manganese Mn to cobalt Co as an average of the whole cathode active material to the atomic ratio [Mn(S)/Co(S)] of manganese Mn to cobalt Co in the surface of the cathode active material, the high capacitance is obtained and the discharge capacitance maintaining ratio is improved as compared with that in Comparison 1 in which the modification is not made and that in Comparison 2 in which the ratio [Mn(T)Co(S)/Mn(S)Co(T)] is larger than the ratio [Ni(T)Co(S)/Ni(S)Co(T)].

That is, it has been found that in the cathode active material having the composite oxide particle containing at least lithium Li and cobalt Co and the coating layer which is provided in at least a part of the composite oxide particle and has the oxide containing lithium Li and the element of at least one of nickel Ni, manganese Mn, and cobalt Co, by setting in such a manner that the ratio [Ni(T)Co(S)/Ni(S)Co(T)] of the atomic ratio [Ni(T)/Co(T)] of nickel Ni to cobalt Co as an average of the whole cathode active material to the atomic ratio [Ni(S)/Co(S)] of nickel Ni to cobalt Co in the surface of the cathode active material is larger than the ratio [Mn(T)Co(S)/Mn(S)Co(T)] of the atomic ratio [Mn(T)/Co(T)] of manganese Mn to cobalt Co as an average of the whole cathode active material to the atomic ratio [Mn(S)/Co(S)] of manganese Mn to cobalt Co in the surface of the cathode active material, the battery which has the high capacitance and is excellent in charge/discharge circle characteristics when the cathode active material is used for the battery is obtained.

The present application is not limited to the foregoing embodiment but various modifications and applications are possible. For example, a shape of the non-aqueous electrolyte secondary battery using the cathode active material according to an embodiment is not particularly limited. For example, the battery can also have any one of a rectangular shape, a coin shape, a button shape, and the like besides the cylindrical shape.

Although the first example of the non-aqueous electrolyte secondary battery has been described with respect to the non-aqueous electrolyte secondary battery having the electrolytic solution as an electrolyte and the second example of the non-aqueous electrolyte secondary battery has been described with respect to the non-aqueous electrolyte secondary battery having the gel electrolyte as an electrolyte, the application is not limited to them.

For example, besides the foregoing materials, a high molecular solid electrolyte using an ion conductive high polymer, an inorganic solid electrolyte using an ion conductive inorganic material, or the like can be also used as an electrolyte. They can be used solely or may be combined with another electrolyte and used. As a high molecular compound which can be used for the high molecular solid electrolyte, for example, polyether, polyester, polyphosphazene, polysiloxane, or the like can be mentioned. As an inorganic solid electrolyte, for example, ion conductive ceramics, ion conductive crystal, ion conductive glass, or the like can be mentioned.

Further, for example, the electrolytic solution of the non-aqueous electrolyte secondary battery is not particularly limited but the non-aqueous solvent system electrolytic solution in the related art or the like is used. Among them, as an electrolytic solution of the secondary battery constructed by a non-aqueous electrolytic solution containing an alkali metal salt, propylene carbonate, ethylene carbonate, γ-butyrolactone, N-methylpyrrolidone, acetonitrile, N,N-dimethyl formamide, dimethyl sulfoxide, tetrahydrofuran, 1,3-dioxorane, methyl formate, sulfolan, oxazolidone, thionyl chloride, 1,2-dimethoxy ethane, diethylene carbonate, their derivatives or mixtures, or the like is preferably used. As an electrolyte contained in the electrolytic solution, an alkali metal, particularly, a halide of calcium, perchlorate, thiocyanic salt, boron fluoride salt, phosphorus fluoride salt, arsenic fluoride salt, yttrium fluoride salt, trifluoromethyl sulfate, or the like is preferably used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A cathode active material comprising:
a composite oxide particle containing at least lithium Li and cobalt Co; and
a coating layer which is provided in at least a part of said composite oxide particle and has an oxide containing lithium Li and an element of at least one of nickel Ni, manganese Mn, and cobalt Co,
wherein a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in a surface of said cathode active material
is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of said cathode active material.

2. The cathode active material according to claim 1, wherein mean compositions of said composite oxide particle are expressed by Formula 1:
Li₍₁₊ₓ₎CO_{(1-y)}M_{y}O_{(2-z)} (Formula 1)
where, in Formula 1, M denotes an element of one or more kinds selected from a group containing magnesium Mg, aluminum Al, boron B, titanium Ti, vanadium V, chromium Cr, manganese Mn, iron Fe, nickel Ni, copper Cu, zinc Zn, molybdenum Mo, tin Sn, and tungsten W; x indicates a value within a range of −0.10≦x≦0.10; y indicates a value within a range of 0≦y<0.50; and z indicates a value within a range of −0.10≦z≦0.20.

3. The cathode active material according to claim 1, wherein a construction ratio (Ni:Mn) of said nickel Ni to said manganese Mn in said coating layer lies within a range from 99:1 to 30:70 as a mole ratio.

4. The cathode active material according to claim 1, wherein 40 mol % or less of a total amount of said nickel Ni and said manganese Mn in the oxide of said coating layer is replaced by a metal element of at least one kind selected from a group containing magnesium Mg, aluminum Al, boron B, titanium Ti, vanadium V, chromium Cr, iron Fe, cobalt Co, copper Cu, zinc Zn, molybdenum Mo, tin Sn, and tungsten W.

5. The cathode active material according to claim 1, wherein an amount of said coating layer lies within a range from 0.5 weight % to 50 weight % of said composite oxide particle.

6. A non-aqueous electrolyte secondary battery comprising: a cathode containing a cathode active material; an anode; and an electrolyte,
wherein said cathode active material has
a composite oxide particle containing at least lithium Li and cobalt Co and
a coating layer which is provided in at least a part of said composite oxide particle and has an oxide containing lithium Li and an element of at least one of nickel Ni, manganese Mn, and cobalt Co, and
a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in a surface of said cathode active material
is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/Co(S)] of manganese Mn to cobalt Co in the surface of said cathode active material.

7. The non-aqueous electrolyte secondary battery according to claim 6, wherein mean compositions of said composite oxide particle are expressed by Formula 1:
Li_{(1+X)}CO_{(1-y)}M_{y}O_{(2-z)} (Formula 1)
where, in Formula 1, M denotes an element (elements) of one or more kinds selected from a group containing magnesium Mg, aluminum Al, boron B, titanium Ti, vanadium V, chromium Cr, manganese Mn, iron Fe, nickel Ni, copper Cu, zinc Zn, molybdenum Mo, tin Sn, and tungsten W; x indicates a value within a range of −0.10≦x≦0.10; y indicates a value within a range of 0≦y<0.50; and z indicates a value within a range of −0.10≦z≦0.20).

8. The non-aqueous electrolyte secondary battery according to claim 6, wherein a construction ratio (Ni:Mn) of said nickel Ni to said manganese Mn in said coating layer lies within a range from 99:1 to 30:70 as a mole ratio.

9. A manufacturing method of a cathode active material, comprising:
forming a layer containing a hydroxide of nickel Ni and/or a hydroxide of manganese Mn into at least a part of a composite oxide particle containing at least lithium Li and cobalt Co; and
forming a coating layer which is provided in at least a part of said composite oxide particle by heat-processing the composite oxide particle formed with said layer and has an oxide containing lithium Li and an element of at least one of nickel Ni, manganese Mn, and cobalt Co,
wherein in said composite oxide particle formed with said coating layer,
a ratio [Ni(T)Co(S)/Ni(S)Co(T)] of an atomic ratio [Ni(T)/Co(T)] of nickel Ni to cobalt Co as an average of the whole cathode active material to an atomic ratio [Ni(S)/Co(S)] of nickel Ni to cobalt Co in a surface of said cathode active material
is larger than a ratio [Mn(T)Co(S)/Mn(S)Co(T)] of an atomic ratio [Mn(T)/Co(T)] of manganese Mn to cobalt Co as an average of the whole cathode active material to an atomic ratio [Mn(S)/CO(S)] of manganese Mn to cobalt Co in the surface of said cathode active material.

10. The manufacturing method of the cathode active material according to claim 9, wherein mean compositions of said composite oxide particle are expressed by Formula 1:
Li₍₁₊ₓ₎Co_{(1-y)}M_{y}O_{(2-z)} (Formula 1)
where, in Formula 1, M denotes an element of one or more kinds selected from a group containing magnesium Mg, aluminum Al, boron B, titanium Ti, vanadium V, chromium Cr, manganese Mn, iron Fe, nickel Ni, copper Cu, zinc Zn, molybdenum Mo, tin Sn, and tungsten W; x indicates a value Within a range of −0.10≦x≦0.10; y indicates a value within a range of 0≦y<0.50; and z indicates a value within a range of −0.10≦z≦0.20.

11. The manufacturing method of the cathode active material according to claim 9, wherein the creation of the hydroxide of said nickel Ni and/or the hydroxide of said manganese Mn
is executed by dispersing said composite oxide particle into a solvent constructed mainly by water whose pH is equal to or larger than 12 and, thereafter, adding a compound of nickel Ni and/or a compound of manganese Mn.

12. The manufacturing method of the cathode active material according to claim 11, wherein said solvent constructed mainly by the water contains a lithium hydroxide.

13. The manufacturing method of the cathode active material according to claim 9, wherein a construction ratio (Ni:Mn) of said nickel Ni to said manganese Mn in said coating layer lies within a range from 99:1 to 30:70 as a mole ratio.

14. The manufacturing method of the cathode active material according to claim 9, wherein 40 mol % or less of a total amount of said nickel Ni and said manganese Mn in the oxide of said coating layer is replaced by a metal element of at least one kind selected from a group containing magnesium Mg, aluminum Al, boron B, titanium Ti, vanadium V, chromium Cr, iron Fe, cobalt Co, copper Cu, zinc Zn, molybdenum Mo, tin Sn, and tungsten W.

15. The manufacturing method of the cathode active material according to claim 9, wherein an amount of said coating layer lies within a range from 0.5 weight % to 50 weight % of said composite oxide particle.
